(19) United States
(12) Patent Application Publication
(10) Pub. No.: US 2025/0387910 A1
(43) Pub. Date: Dec. 25, 2025

(54) ROBOTIC DEVICE CONTROL METHOD AND ROBOTIC DEVICE USING THE SAME

(71) Applicant: Futronics (NA) Corporation, Pasadena, CA (US)

(72) Inventors: Fulan LI, Pasadena, CA (US); Yunfei Guo, Pasadena, CA (US); Wenda Xu, Pasadena, CA (US); Weide Zhang, Pasadena, CA (US); Fangyun Zhao, Pasadena, CA (US); Baiyu Wang, Pasadena, CA (US); Huaguang Du, Pasadena, CA (US); Chengkun Zhang, Pasadena, CA (US)

(21) Appl. No.: 18/890,827

(22) Filed: Sep. 20, 2024

Related U.S. Application Data
(60) Provisional application No. 63/662,409, filed on Jun. 20, 2024.

(51) Int. Cl. B25J 9/16; B25J 11/00; B25J 13/08

(52) U.S. Cl. CPC B25J 9/1664; B25J 9/1651; B25J 11/009; B25J 13/085

(57) ABSTRACT

Robotic device control for assisting a user in performing upper limb rehabilitation is disclosed. A method controls a robotic device having a non-backdrivable end-effector including motor(s) and position sensor(s) by: receiving trajectory restriction(s); generating a motion restriction map based on the received trajectory restriction(s); receiving, through the position sensor(s) of the end-effector, a current position of the end-effector; obtaining a desired velocity for the motor(s) at a current time by modifying, based on the generated motion restriction map and the received current position, a calculated velocity obtained based on the desired velocity at a previous time to limit the end-effector to move inside a permitted area represented by the motion restriction map; providing a movement instruction including the obtained desired velocity at the current time; and controlling the end-effector to move according to the provided movement instruction

### CROSS-REFERENCE TO RELATED APPLICATIONS

This application claims the priority and benefit of U.S. provisional application No. 63/662,409, titled “DESIGN AND CONTROL OF A LOW-COST NON-BACKDRIVABLE END-EFFECTOR UPPER LIMB REHABILITATION DEVICE” and filed Jun. 20, 2024 the entire contents of which are incorporated herein by reference.

### TECHNICAL FIELD

The present disclosure relates to robotic technology, and particularly to a robotic device control method and a robotic device using the same.

### BACKGROUND

Robotic-assisted therapy (RAT) has been found to be a valuable adjunct to conventional physical therapy for poststroke upper extremity rehabilitation, particularly for subacute stroke patients. Compared to conventional physical therapy, RAT allows patients to undergo consistent and repetitive rehabilitation exercises, showing comparable and better outcomes. Among those frequently researched RAT devices (e.g., end-effector devices and rehabilitation exoskeletons), the end-effector rehabilitation devices like end-effector upper limb rehabilitation devices that are planar robots enabling movement along a 2D plane are particularly popular due to their portability and affordability.

There are three primary types of end-effector rehabilitation robots: multi-link robots, pulley-drive robots, and linear actuated robots. Among them, the multi-link robots have portable and backdrivable direct drive mechanisms providing high accuracy while remain challenging in maintaining the stability of the vertical force resulting from the user placing their arm on the device and impacts on user experience, motivation, engagement, and product adoption rate are caused; and the pulley-drive robots attempted to employ a differential drive with pulleys and belts to address the stability issues and improve dynamics calculation while require high maintenance due to the frequent wear and tear on the belt drives.

The linear actuated robots that may include backdrivable/non-backdrivable end-effector provide some possibilities to solve the forgoing issues. However, implementing end-effector area restriction control on a non-backdrivable mechanism using motor velocity control presents the challenge of position error accumulation arising from both the control discretization and the motor acceleration limitations. Although increasing the control frequency and using higher quality motors can reduce the position error, it cannot be entirely eliminated and tends to accumulate over time.

### BRIEF DESCRIPTION OF DRAWINGS

In order to more clearly illustrate the technical solutions in this embodiment, the drawings used in the embodiments or the description of the prior art will be briefly introduced below. In the drawing(s), like reference numerals designate corresponding parts throughout the figures. It should be understood that, the drawings in the following description are only examples of the present disclosure. For those skilled in the art, other drawings can be obtained based on these drawings without creative works.

FIG. 1 is a schematic diagram of a scenario of upper limb rehabilitation using a robotic device according to some embodiments of the present disclosure.

FIG. 2 is a schematic diagram of an example of the robotic device of FIG. 1.

FIG. 3 is a schematic block diagram illustrating the robotic device of FIG. 2.

FIG. 4 is a schematic block diagram of an example of controlling the robotic device of FIG. 3.

FIG. 5 is a schematic diagram of a control hierarchy of the robotic device of FIG. 3 and that of a robot-guided trajectory mode.

FIG. 6 is a flow chart of an example of receiving trajectory restriction and generating map according to some embodiments of the present disclosure.

FIG. 7 is a schematic diagram of an example of obtaining a desired velocity in the robot-guided trajectory mode.

FIG. 8 is a flow chart of an example of generating a motion restriction map and a spring force map according to some embodiments of the present disclosure.

FIG. 9A is a flow chart of an example of obtaining the desired velocity according to some embodiments of the present disclosure.

FIG. 9B is a schematic diagram of calculating implicit Euler velocity control (IEVC) in the example of obtaining the desired velocity in FIG. 9A.

FIG. 10 is a schematic diagram of the desired positions and the measured positions of the end-effector and error analysis in the robot-guided trajectory mode.

FIG. 11 is a schematic diagram of a control hierarchy of a free mode and a hard-boundary human-guided trajectory mode and that of a soft-boundary human-guided trajectory mode of the robotic device of FIG. 3.

FIG. 12 is a schematic diagram of an example of obtaining the desired velocity in a free mode and a hard-boundary human-guided trajectory mode.

FIG. 13 is a schematic diagram of an experiment of allowing six objects with different masses to move freely on task space with a friction coefficient of 0.02 by using admittance virtual dynamics in the free mode.

FIG. 14 is a schematic diagram of range of motion (ROM) restriction map generation and evaluation in the free mode.

FIG. 15 is a schematic diagram of an experiment in the hard-boundary human-guided trajectory mode with random noise injected.

FIG. 16 is a schematic diagram of an experiment of characteristics of an impedance force zone in the soft-boundary human-guided trajectory mode.

FIG. 17 is a schematic diagram of an example of obtaining the desired velocity in the soft-boundary human-guided trajectory mode.

FIG. 18 is a schematic diagram of an example of calculating impedance force for a hand-drawn motion restriction map in the soft-boundary human-guided trajectory mode.

### DETAILED DESCRIPTION

In order to make the objects, features and advantages of the present disclosure more obvious and easy to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including”, “comprising”, “having” and their variations indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

In the present disclosure, the terms “first”, “second”, and “third” are for descriptive purposes only, and are not to be comprehended as indicating or implying the relative importance or implicitly indicating the amount of technical features indicated. Thus, the feature limited by “first”, “second”, and “third” may include at least one of the feature either explicitly or implicitly. In the description of the present disclosure, the meaning of “a plurality” is at least two, for example, two, three, and the like, unless specifically defined otherwise.

In the present disclosure, the descriptions of “one embodiment”, “some embodiments” or the like described in the specification mean that one or more embodiments of the present disclosure can include particular features, structures, or characteristics which are related to the descriptions of the descripted embodiments. Therefore, the sentences “in one embodiment”, “in some embodiments”, “in other embodiments”, “in other embodiments” and the like that appear in different places of the specification do not mean that descripted embodiments should be referred by all other embodiments, but instead be referred by “one or more but not all other embodiments” unless otherwise specifically emphasized.

The present disclosure relates to controlling a robotic device with non-backdrivable mechanism for assisting a user in performing limb rehabilitation. As used herein, the term “robotic device” refers to a machine such as a gantry arm rehabilitation device (GARD) that includes mechanical components, logic circuitry, computing components, software and/or other specialized components that desired and/or measured force, torque, position, orientation, velocity, and/or angular velocity information is processed by a computing source and such computing source is used to control the force, torque, position, orientation, velocity, angular velocity, and/or physical configuration of the device. The term “non-backdrivable mechanism” refers to a mechanism that allows transmitting the motion from an input mechanical element to an output load but blocks any movement of the output load when the input element is left free. The term “end-effector” refers to a part of a robotic device interacting with its environment to perform its functions. The term “sensor” refers to a device, module, machine, or subsystem such as force sensor (e.g., torque sensor) and image sensor (e.g., camera) whose purpose is to detect events or changes in its environment and send the information to other electronics (e.g., processor).

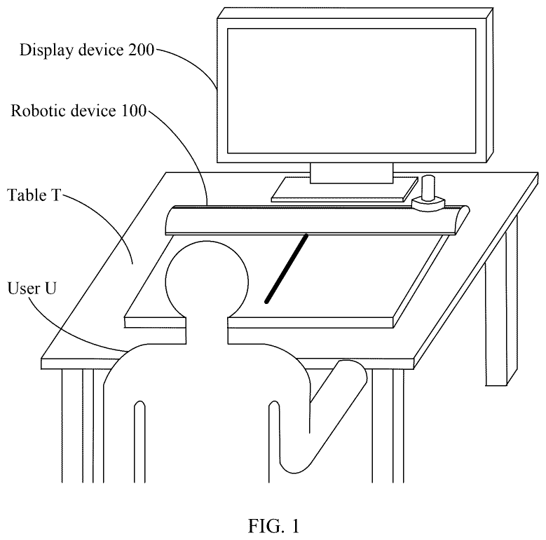

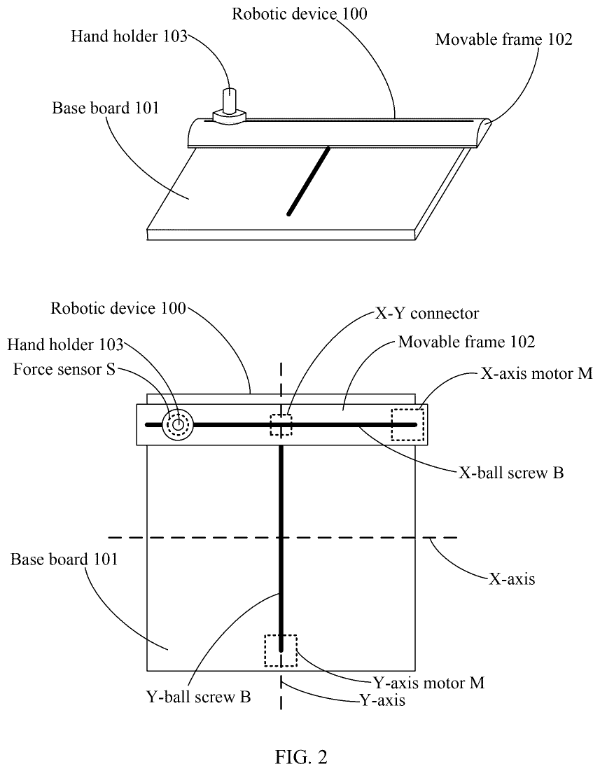

FIG. 1 is a schematic diagram of a scenario of upper limb rehabilitation using a robotic device according to some embodiments of the present disclosure. In the scenario (e.g., nursing home, hospital, or home) for a user U (e.g., a patient needs rehabilitation because of an illness such as a stroke) to perform rehab activities, rehabilitation equipment like the robotic device 100 (and auxiliary equipment like the display device 200) may be provided to realize physical therapies. FIG. 2 is a schematic diagram of an example of the robotic device 100 of FIG. 1. In some embodiments, the robotic device 100 is a GARD with non-backdrivable mechanism that offers a flexible range of motion (ROM) within an area (e.g., a square area of 65×55 cm) of 2D workspace. The robotic device 100 can provide rehabilitation-related functions by putting on a table T or other suitable supporter for the user U to operate in a suitable posture like sitting to perform upper limb rehabilitation activities, which may include a base board 101, a movable frame 102 mounted on the base board 101 in a movable manner such as slidable in a Y-axis direction (i.e., the direction aligned with a Y-axis of a coordinate system of the robotic device 100) along a rail of the base board 101, and a hand holder 103 (i.e., a handle) mounted on the movable frame 102 in a movable manner such as slidable in an X-axis direction (i.e., the direction aligned with an X-axis of the coordinate system of the robotic device 100) along a rail of the movable frame 102.

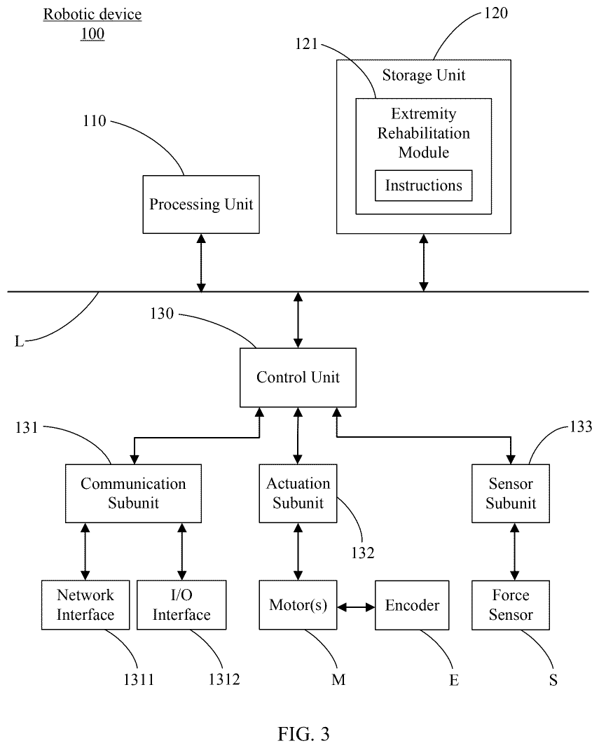

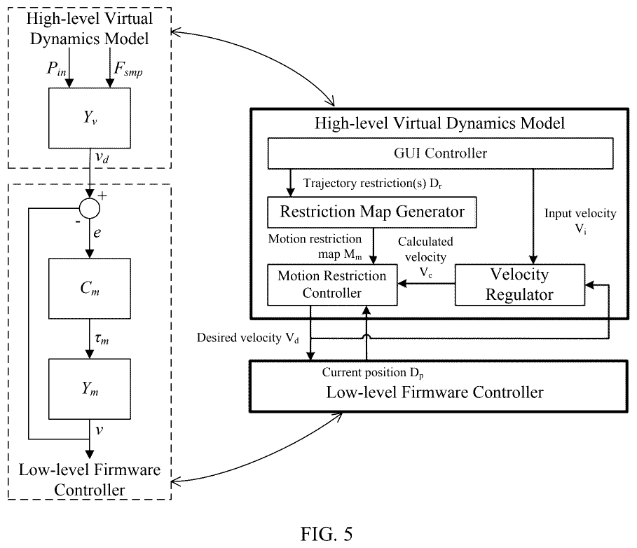

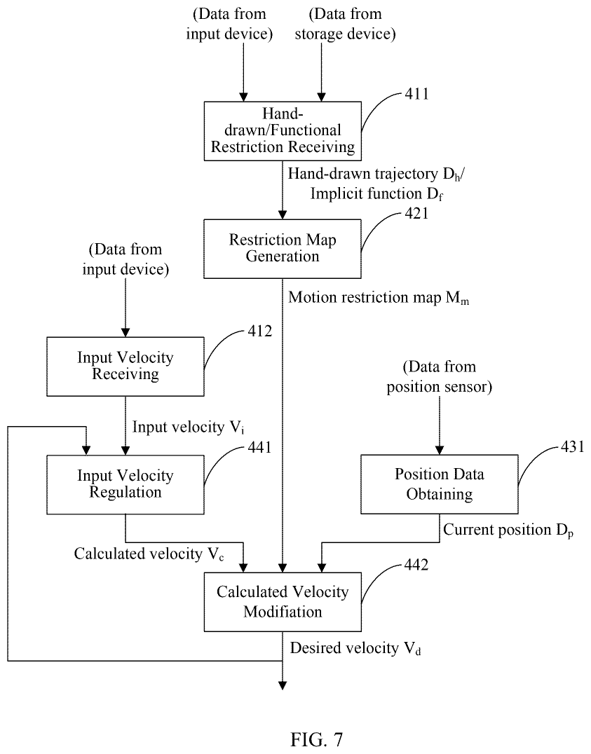

The base board 101 includes a Y-ball screw B and a Y-axis motor M, the Y-axis motor M is for being rotated to move the movable frame 102 through the Y-ball screw B along the Y-direction. The movable frame 102 includes an X-ball screw B and an X-axis motor M, the X-axis motor M is for being rotated to move the hand holder 103 through the X-ball screw B along the X-direction. The X-ball screw B and the Y-ball screw B are connected through an X-Y connector. Each of the base board 101 and the movable frame 102 forms a non-backdrivable ball-screw-driven mechanism (i.e., ball-screw-driven linear actuator). By utilizing two rotary actuators (i.e., the X-axis motor M and the Y-axis motor M) coupled with ball screws (i.e., the X-ball screw B and the Y-ball screw B), the robotic device 100 enables linear movement along the X-axis and the Y-axis. Each of the X-axis motor M and the Y-axis motor M may include an encoder E (see FIG. 3) which is a position sensor for tracking a current position of the motor M (see current position Dₚ in FIG. 5 and FIG. 7). The encoder E may be, for example, a 1000CPR resolution optical encoder, and the robotic device 100 may have two motor controllers each for the X-axis motor M and the Y-axis motor M that are incorporated to connect with two brushless DC motors (i.e., the X-axis motor M and the Y-axis motor M) equipped with the optical encoders for precise control over the X-ball screw B and the Y-ball screw B. In addition, the robotic device 100 may have two limit switches for motor-homing purposes. The hand holder 103 features a non-backdrivable end-effector of the robotic device 100 on the basis of the non-backdrivable ball-screw-driven mechanisms of the base board 101 and the movable frame 102, which is for supporting an upper limb of the user U. The hand holder 103 may include a force sensor S which may be, for example, a Galoce GPB160 3-axis load cell utilizing an ADS1232 SPI ADC converter. When the user U operates the robotic device 100 through the hand holder 103, the upper limb is moved upon the base board 101 with the movement of the hand holder 103, thereby performing the upper limb rehabilitation activities. To manage low-level control and communication with the high-level controller, the limit switches, ADC converters, and motor drivers may be all interfaced with an STM32 microcontroller unit (MCU). As an example, the ball screws (i.e., the X-ball screw B and the Y-ball screw B) may operate at a ratio of 1 turn to 2 millimeters, and the rotary actuators (i.e., the X-axis motor M and the Y-axis motor M) may achieve a maximum speed of 80 revolutions per second with acceleration limited to 800 revolutions per second squared, where each actuator may provide a maximum torque output of 0.22 Nm. Compared to conventional multi-link robots, the robotic device 100 is capable of offering better stability along a Z-axis direction (i.e., the direction aligned with a Z-axis of the coordinate system of the robotic device 100), and compared to the pulley-belt driven robots, the robotic device 100 exhibits enhanced wear resistance, owing to its ball-screw direct drive mechanism.

The robotic device 100 may detect forces from the user U through the force sensor S, thereby providing force feedbacks corresponding to the detected forces to simulate real-world physical touch by way of, for example, motorized motion or resistance. The display device 200 may be a display screen that facilitates the user U to perform the upper limb rehabilitation activities by, for example, providing related textual/audio/graphical instructions, introductions, suggestions, or the like, which may include a stereo, and sensor(s) like a camera for capturing images of the surroundings of the user U. In other embodiments, the display device 200 may be other display device like a headset, a multi-projected environment, or the like to generate realistic images. In addition, other feedbacks like haptic feedback may be provided through the robotic device 100 or other devices like joysticks.

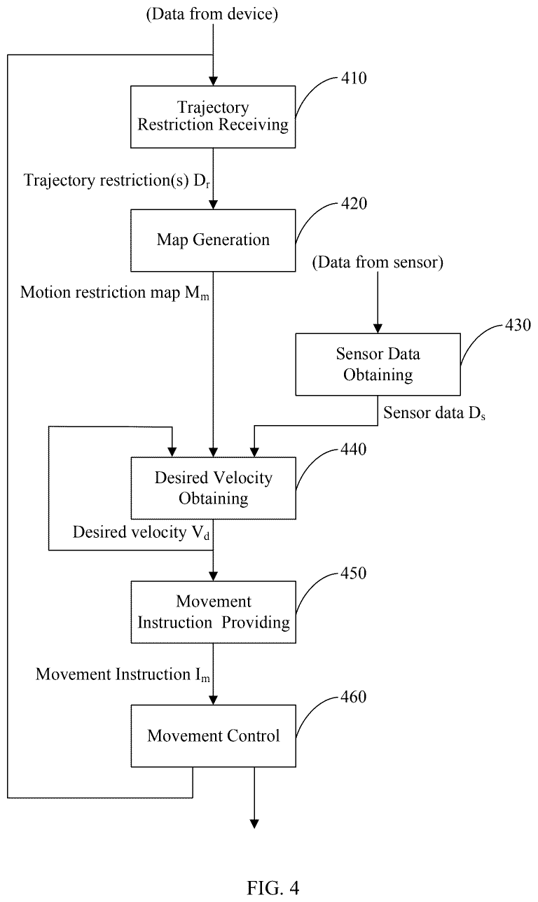

FIG. 3 is a schematic block diagram illustrating the robotic device 100 of FIG. 2. The robotic device 100 may include a processing unit 110, a storage unit 120, and a control unit 130 that communicate over one or more communication buses or signal lines L. It should be noted that, the robotic device 100 is only one example of robotic device, and the robotic device 100 may have more or fewer components (e.g., unit, subunits, and modules) than shown in above or below, may combine two or more components, or may have a different configuration or arrangement of the components. As an example, the robotic device 100 may have a power source that is a medical-grade power supply with a rated output of 24V and 6.5 A, where the power supply may be distributed via a power distribution board to various components including the processing unit 110, the storage unit 120, and the control unit 130. The processing unit 110 executes various (sets of) instructions stored in the storage unit 120 that may be in form of software programs to perform various functions for the robotic device 100 and to process related data, which may include one or more processors (e.g., CPU). The storage unit 120 may include one or more memories (e.g., high-speed random-access memory (RAM) and non-transitory memory), one or more memory controllers, and one or more non-transitory computer readable storage mediums (e.g., solid-state drive (SSD) or hard disk drive). The control unit 130 may include various controllers (e.g., network interface controller, or physical button controller) and peripherals interface for coupling the input and output peripheral of the robotic device 100, for example, external port (e.g., USB), wireless communication circuit (e.g., RF communication circuit), audio circuit (e.g., speaker circuit), sensor (e.g., the force sensor S), and the like, to the processing unit 110 and the storage unit 120. In some embodiments, the storage unit 120 may include an extremity rehabilitation module 121 for implementing upper limb rehabilitation functions related to the above-mentioned upper limb rehabilitation activities (e.g., mechanical/electronical functions to control the robotic device 100 so as to enable the user U to perform the upper limb rehabilitation activities), which may be stored in the one or more memories (and the one or more non-transitory computer readable storage mediums). The extremity rehabilitation module 121 may be a software module (of the operation system of the robotic device 100), which has instructions (e.g., instruction for actuating motor(s) M of the robotic device 100 like movement instruction Iₘ in FIG. 4) for implementing the above-mentioned upper limb rehabilitation functions.

The robotic device 100 may further include a communication subunit 131 and an actuation subunit 132. The communication subunit 131 and the actuation subunit 132 communicate with the control unit 110 over one or more communication buses or signal lines that may be the same or at least partially different from the above-mentioned one or more communication buses or signal lines L. The communication subunit 131 is coupled to communication interfaces of the robotic device 100, for example, network interface(s) 1311 for the robotic device 100 to communicate with the display device 200 via network(s), I/O interface(s) 1312 (e.g., a physical button), and the like. The actuation subunit 132 is coupled to component(s)/device(s) for implementing the motions of the robotic device 100 that include the motor(s) M (i.e., the X-axis motor M and the Y-axis motor M) by, for example, actuating the motor(s) M of joints of the robotic device 100. The communication subunit 131 may include controllers for the above-mentioned communication interfaces of the robotic device 100, and the actuation subunit 132 may include controller(s) for the above-mentioned component(s)/device(s) for implementing the motions of the robotic device 100 (e.g., the above-mentioned motor controllers). The low-level firmware of the control unit 130 may continuously send the current reading of the encoder E and the force sensor S to the high-level control system (e.g., the extremity rehabilitation module 121). In other embodiments, the communication subunit 131 and/or actuation subunit 132 may just abstract component for representing the logical relationships between the components of the robotic device 100.

The robotic device 100 may further include a sensor subunit 133 which may include a set of sensor(s) and related controller(s), for example, the force sensor S, for detecting forces from the user U. The sensor subunit 133 communicates with the control unit 110 over one or more communication buses or signal lines that may be the same or at least partially different from the above-mentioned one or more communication buses or signal lines L. In some embodiments, the various components shown in FIG. 3 may be implemented in hardware, software or a combination of both hardware and software. Two or more of the processing unit 110, the storage unit 120, the control unit 110, the extremity rehabilitation module 121, and other units/subunits/modules may be implemented on a single chip or a circuit. In other embodiments, the sensor subunit 133 may further include a camera, for detecting the situation of the user U to facilitate the above-mentioned upper limb rehabilitation functions. The sensor subunit 133 may just abstract component for representing the logical relationships between the components of the robotic device 100. In addition, at least a part of them may be implemented on separate chips or circuits.

A common practice in implementing velocity control-based trajectory following algorithms is to decompose the current velocity into tangential and radial velocity and adjust them accordingly. However, these types of algorithms share a common issue such that the trajectory following error can accumulate over time resulting in increased deviation. Take circular trajectory as an example, a trivial way to limit the movement of the end-effector on a circular trace is to dynamically calculate the tangential direction at current position and march only in that direction, while the error caused by the control discretization and the motor acceleration limitations will accumulate and will cause the end-effector to move further away over time. To address the above-mentioned issue on a GARD like the robotic device 100, a specific control mechanism (or algorithm), namely implicit Euler velocity control (IEVC) mechanism (or algorithm) for motion restriction and trajectory following may be used to enable different operation modes Go (not shown) of the robotic device 100 while the position error accumulation issue can be solved. The IEVC mechanism is initially used in solving the position error accumulation issue in free moving along an arbitrary trajectory restriction, and now it's use is extended to 2D area restriction and even 3D space restriction. In the present disclosure, the IEVC mechanism is used to addresses the challenge of position error accumulation arising from both the control discretization and the motor acceleration limitations when implementing area restriction control of the end-effector on the non-backdrivable mechanism using motor velocity control. FIG. 4 is a schematic block diagram of an example of controlling the robotic device 100 of FIG. 3. In some embodiments, an upper limb rehabilitation process (e.g., an upper limb rehabilitation game) is implemented in the robotic device 100 to, with the auxiliary of the display device 200, assist the user U to perform the upper limb rehabilitation activities by, for example, storing (sets of) instructions corresponding to the upper limb rehabilitation process (e.g., instructions for controlling the motors M) as the extremity rehabilitation module 121 in the storage unit 120 and executing the stored instructions through the processing unit 110, so that the robotic device 100 can be controlled accordingly. The upper limb rehabilitation process may be performed in response to actuating the robotic device 100 through, for example, physical button(s) or a remote control of the robotic device 100. In other embodiments, the upper limb rehabilitation process may also be performed in response to a request from, for example, (the operation system of) the robotic device 100 or the display device 200.

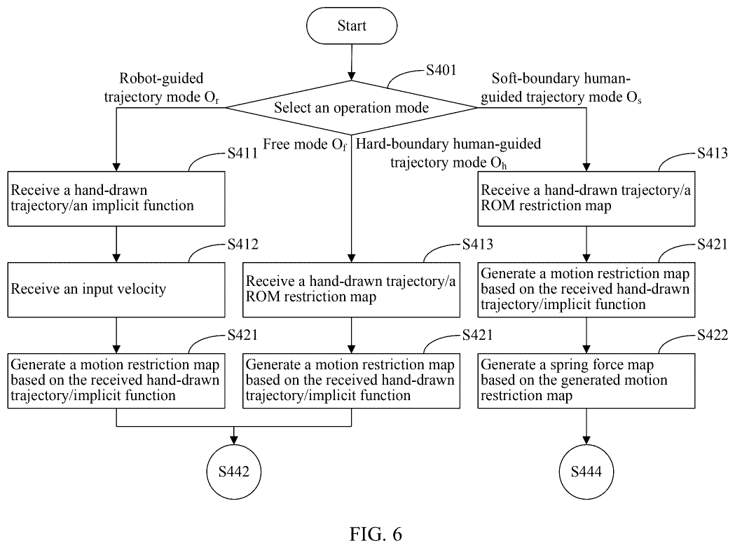

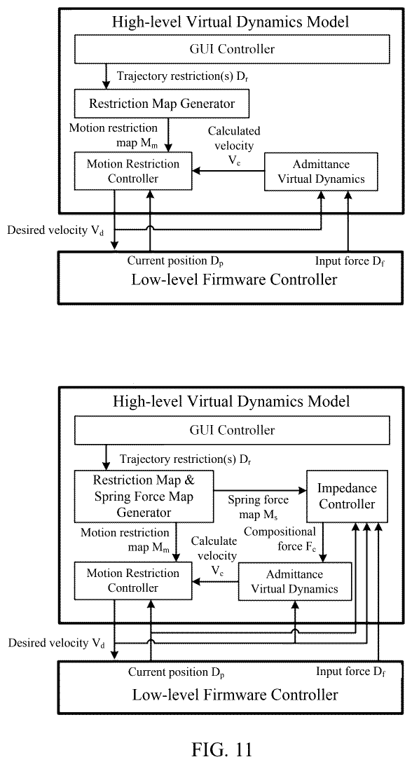

The robotic device 100 like other end-effector upper limb rehabilitation device which typically offer three training function tailored to specific rehabilitation interventions, namely robot-guided trajectory following, human-guided trajectory following, and free-moving. These training function aim to map the sequential stages of physical therapy. The robot-guided trajectory following function is primarily utilized in the early stages of rehabilitation for stretching and passive ROM exercises, which allows the user U to follow a predetermined 2D trajectory operated by the robotic device 100, without using strength or exerting forces; the human-guided trajectory following function attempts to facilitate active ROM exercises and resistance training, which provides assistance or resistance as needed; and the free-moving function can be used in a later recovery stage to facilitate participation in rehabilitation games and promote sensorimotor training, which allows unrestricted movement of the user U within a 2D workspace, facilitating engagement with rehabilitation games, promoting sensorimotor training, and enhancing tactile feedback, motor planning, and sensory and proprioceptive awareness. FIG. 5 is a schematic diagram of a control hierarchy of the robotic device 100 of FIG. 3 and that of a robot-guided trajectory mode Oᵣ (see FIG. 6). From a software point of view, the robotic device 100 features a two-level control hierarchy including a high-level virtual dynamics model and a low-level firmware controller. The left part of FIG. 5 shows the simplified two-level control hierarchy of the robot-guided trajectory mode Oᵣ that corresponds to the above-mentioned robot-guided trajectory following function. Accordingly, at the high level, the virtual dynamics model computes a desired velocity v_{d} (i.e., the desired velocity V_{d} in the right part of FIG. 5) based on sensor data like current position data Pᵢₙ of the motor M (i.e., the current position Dₚ in the right part of FIG. 5) and force data Fₛₘₚ from the force sensor S (i.e., input force D_{f} in FIG. 11), and settings made by the user U (e.g., input velocity Vᵢ in the right part of FIG. 5), where Yᵥ denotes virtual dynamics of the robotic device 100. At the low level, the firmware controller (e.g., the above-mentioned MCU and two motor controllers) manages sensor data collection, timing regulation, and motor control, and eventually output a velocity v for the motor M, thereby realizing close loop velocity control. In which, +− denotes a summation node where − means the input is negative, e is the error between desired velocity v_{d} and the measured output velocity Cₘ denotes the above-mentioned motor controller, τₘ is the torque output by the motor M, and Yₘ denotes (physical) dynamics of the robotic device 100. The right part of FIG. 5 shows the two-level control hierarchy of the robot-guided trajectory mode Oᵣ. The dynamics model may be the extremity rehabilitation module 121, and the firmware controller may be controllers in the actuation subunit 132 like the above-mentioned motor controllers. From a mechanical point of view, (the base board 101 and the movable frame 102 of) the robotic device 100 features the above-mentioned non-backdrivable mechanism, in which the input force D_{f} in FIG. 11 from the user U does not influence the motion of the end-effector (i.e., the hand holder 103), allowing the separation of simulated dynamic (i.e., the virtual dynamics model) and robot dynamics (i.e., the firmware controller). In comparison with the conventional admittance control system that the virtual dynamics model and the firmware controller are not separated due to the influence of applied forces on the robot dynamics so that both the input force and the desired velocity must be considered in motor torque calculations, the two-level control hierarchy establishes a clear hierarchy while maximizes the integration advantages of commercial motor controllers, that is, the integrated commercial motor controller firmware dedicated to motor velocity control typically operates at much higher control frequencies, and is more stable and efficient than the implementation on a multitask MCU.

According to the upper limb rehabilitation process, the processing unit 110 may receive, through a restriction map generator of the virtual dynamics model in FIG. 5, trajectory restriction(s) Dᵣ (block 410 of FIG. 4) from a graphical user interface (GUI) controller of the virtual dynamics model. A GUI controller of the virtual dynamics model in FIG. 5 obtains the trajectory restriction(s) Dᵣ (e.g., hand-drawn trajectory Dₕ and implicit function D_{f} in FIG. 7) according to inputs (e.g., hand-drawing on a touch screen of the display device 200) of the user U that are generated by manipulating the GUI displayed on the display device 200. FIG. 6 is a flow chart of an example of receiving trajectory restriction and generating map according to some embodiments of the present disclosure. In some embodiments, before receiving the trajectory restriction(s) Dᵣ, the upper limb rehabilitation process may be first initialed by selecting the operation mode Oₒ of the robotic device 100. Accordingly, at step S401, the operation mode Oₒ that is a mode at which the robotic device 100 operates is selected. The operation mode Oₒ of the robotic device 100 may be selected by, for example, providing a plurality of operation modes Oₒ of the robotic device 100 through the GUI displayed on the display device 200 for the user U to select by manipulating the GUI. The GUI may offer functionalities (e.g., GUI-based functionalities like displaying graphical operation modes) and features (e.g., rehabilitation gaming features) of the upper limb rehabilitation process. The operation modes Oₒ of the robotic device 100 may include the robot-guided trajectory mode Oᵣ, a free mode O_{f}, a hard-boundary human-guided trajectory mode Oₕ, and a soft-boundary human-guided trajectory mode Oₛ. In the robot-guided trajectory mode Oᵣ that corresponds to the above-mentioned robot-guided trajectory following function, the robotic device 100 will automatically follow a preset trajectory at a speed (i.e., the input velocity Vᵢ in FIG. 5 and FIG. 7) obtained (through, for example, a slide bar or an input text box displayed on the GUI where the user U can adjust/input their desired speed) by the GUI controller according to the inputs of the user U that are generated by manipulating the GUI to enable passive rehabilitation training for the upper limb of the user U; in the free mode O_{f} that corresponds to the above-mentioned free-moving function, the user U is allowed to move the end-effector (i.e., the hand holder 103) within the ROM of the user U; in the hard-boundary human-guided trajectory mode Oₕ that corresponds to the above-mentioned human-guided trajectory following function, the user U is allowed to maneuver the end-effector freely along a trajectory with hard boundaries; and in the soft-boundary human-guided trajectory mode Oₛ that corresponds to the above-mentioned human-guided trajectory following function, the user U is allowed to maneuver the end-effector freely along a trajectory with soft boundaries. The hard-boundary human-guided trajectory mode Oₕ and the soft-boundary human-guided trajectory mode Oₛ offer varying degrees of freedom for active ROM training. FIG. 7 is a schematic diagram of an example of obtaining the desired velocity V_{d} in the robot-guided trajectory mode Oᵣ. In the case that the robot-guided trajectory mode Oᵣ is selected, in the trajectory restriction receiving (block 410 of FIG. 4), the processing unit 110 may receive the hand-drawn trajectory Dₕ or the implicit function D_{f} (block 411, see also step S411 of FIG. 6) that belongs to the trajectory restriction(s) Dᵣ from the GUI controller of the virtual dynamics model in FIG. 5, and may also receive the input velocity Vᵢ (block 412, see also step S412 of FIG. 6) from the GUI controller. The hand-drawn trajectory Dₕ or the implicit function D_{f} may be shown to the user U in advance through the GUI displayed by the display device 200, so that the user U can manipulate the GUI to select the hand-drawn trajectory Dₕ (which may be drawn in advance on the GUI) or the implicit function D_{f}. The input velocity Vᵢ may be inputted by the user U through manipulating the GUI displayed on the display device 200.

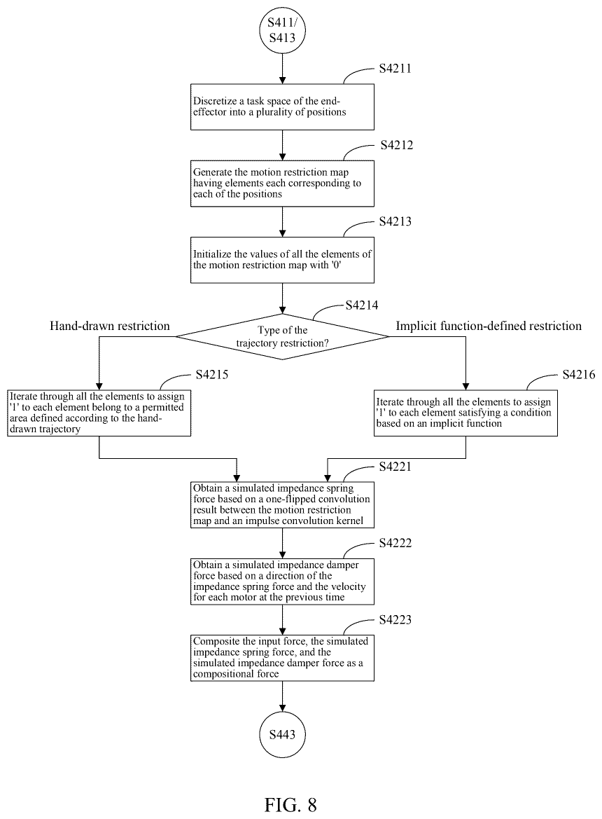

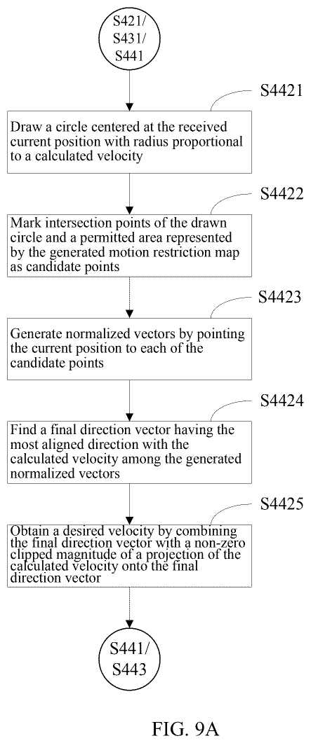

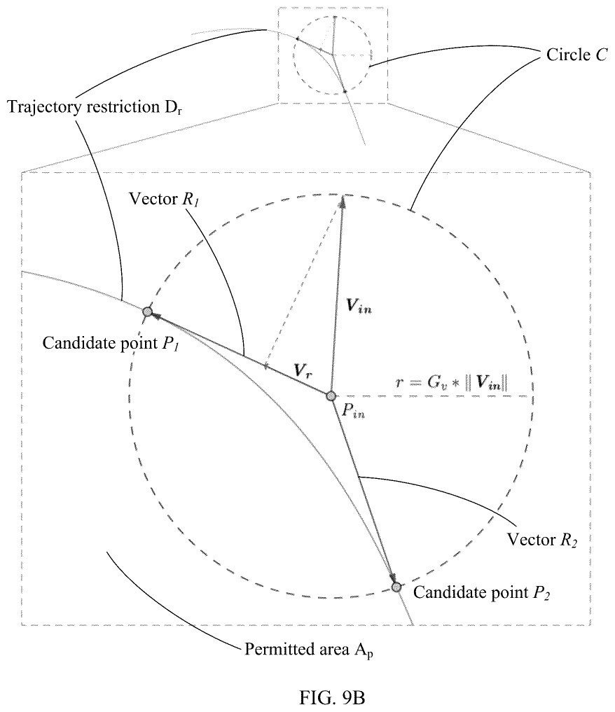

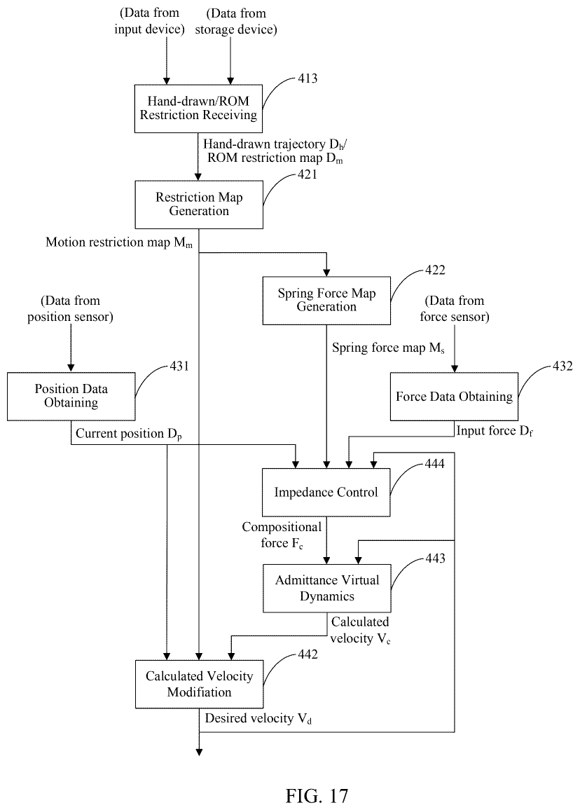

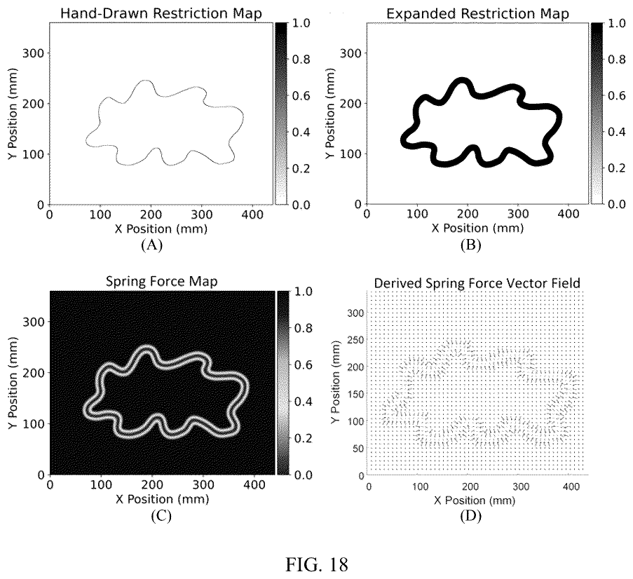

In the IEVC mechanism, motion restriction control is defined as moving control of the end-effector under a virtual positional restriction. The area in which the end-effector is allowed to move freely are defined as a permitted area Aₚ (see FIG. 9B), otherwise are defined a prohibited area A_{f} (not shown). The IEVC mechanism is implemented in a motion restriction controller of the virtual dynamics model in FIG. 5 that performs the motion restriction control, which can effectively restrict the end-effector inside any permitted area Aₚ to enable the end-effector to move freely inside the permitted area Aₚ and interact with a hard-smooth-wall like area boundary by dynamically searching and choosing the best chasing target. The IEVC mechanism and/or the motion restriction controller may be reused in all the operation modes Oₒ. To make the algorithm generalizable to any scenario, it may be implemented upon a discretized task space with W_{g}×H_{g} positions, and use a 2D matrix of equal size which referred to as a motion restriction map Mm (see FIG. 4) to represent the motion restriction of the task space. According to the upper limb rehabilitation process, the processing unit 110 may further generate, through the restriction map generator of the virtual dynamics model in FIG. 5, the motion restriction map Mm (see part (A) of FIG. 18) based on the received trajectory restriction(s) Dᵣ (block 420 of FIG. 4). In the case that the robot-guided trajectory mode Oᵣ is selected, in this map generation, the processing unit 110 may generate, through the restriction map generator of the virtual dynamics model in FIG. 5, the motion restriction map Mm based on the received trajectory restriction Dᵣ (i.e., the hand-drawn trajectory Dₕ or the implicit function D_{f}) (block 421 of FIG. 7, see also step S421 of FIG. 6). FIG. 8 is a flow chart of an example of generating the motion restriction map Mm and a spring force map Mₛ (see the lower part of FIG. 11 and FIG. 17) according to some embodiments of the present disclosure. Accordingly, at step S4211, the task space of the end-effector (i.e., the hand holder 103) of the robotic device 100 is discretized into a plurality of positions. The task space is discretized into W_{g}×H_{g} positions. The task space (i.e., Cartesian space) is defined by the position and orientation of the end-effector. At step S4212, the motion restriction map Mm having elements each corresponding to each of the positions is generated. The elements correspond to the positions in a one-to-one manner, and the motion restriction map Mm can be viewed as a grayscale image where each pixel entry in the motion restriction map Mm corresponds to a physical location of the end effector. Each of the elements stores a value indicating whether the corresponding position is in the permitted area Aₚ or the prohibited area A_{f} for the end-effector. The permitted area Aₚ and the prohibited area A_{f} are defined according to the trajectory restriction Dᵣ. At step S4213, the values of all the elements of the motion restriction map Mm are initialed with 0. The motion restriction map Mm with all the elements of 0 means all the positions therein are the prohibited area A_{f}. At step S4214, it identifies the type of the trajectory restriction Dᵣ. If the trajectory restriction Dᵣ is a hand-drawn restriction (i.e., the hand-drawn trajectory Dₕ), step S4215 will be performed; otherwise, if the trajectory restriction Dᵣ is an implicit function-defined restriction (i.e., the implicit function D_{f}), step S4216 will be performed. At step S4215, all the elements are iterated through to assign the value of 1 to each element of the motion restriction map Mm that belongs to the permitted area Aₚ defined according to the hand-drawn trajectory Dₕ. In this case, the prohibited area A_{f} is also defined according to the hand-drawn trajectory Dₕ. At step S4216, all the elements are iterated through to assign the value of 1 to each element satisfying a condition based on the implicit function D_{f}. For the trajectory restriction Dᵣ defined using an implicit function f(x, y)=0 or a more generalized area restriction defined using another function F(x, y)<0, the motion restriction map Mm may be generated by iterating through all entries [i, j] in the motion restriction map Mm and evaluating abs(f(j, i))<Eₛ or F(j, i)<0, where Eₛ is the trajectory width for the trajectory restriction Dᵣ. For every [i, j] satisfying the above-mentioned function, the corresponding entry [i, j] in the motion restriction map Mm will be assigned 1, which represents the permitted area Aₚ. For other general user-defined motion restrictions such as the hand-drawn trajectory Dₕ, the motion restriction map Mm may be generated and/or edited using an image editing tool provided on the GUI displayed on the display device 200.

The motion restriction controller of the virtual dynamics model in the right part of FIG. 5 performs the IEVC mechanism by taking the calculated velocity V_{c}, the current position Dₚ, and the generated motion restriction map Mm as input to calculate and output the desired velocity V_{d} which is guaranteed to limit the position of the end-effector towards the permitted area Aₚ. According to the upper limb rehabilitation process, the processing unit 110 may further receive, through a sensor (e.g., the encoder E) of the robotic device 100, sensor data Dₛ (block 430 of FIG. 4). In the case that the robot-guided trajectory mode Oᵣ is selected, in this sensor data obtaining, the processing unit 110 may receive, through the position sensor (i.e., the encoder E) of the motors M (i.e., the X-axis motor M and the Y-axis motor M) of the end-effector (i.e., the hand holder 103), the current position Dₚ of the motors M of the end-effector (block 431 of FIG. 7). That is, the current position Dₚ of each of the X-axis motor M and the Y-axis motor M may be received through the encoder E of each of the X-axis motor M and the Y-axis motor M. The processing unit 110 may further obtain, through the motion restriction controller of the virtual dynamics model in FIG. 5, the desired velocity V_{d} for each motor (i.e., the X-axis motor M and the Y-axis motor M) at a current time (i.e., the desired velocity V_{d} newly obtained by the motion restriction controller at the current clock cycle of the operation system of the robotic device 100) by modifying the calculated velocity V_{c} based on the generated motion restriction map Mm and the received current position Dₚ, thereby limiting the end-effector to move inside the permitted area Aₚ represented by the motion restriction map Mm (block 440 of FIG. 4). The calculated velocity V_{c} is obtained based on the desired velocity V_{d} at a previous time (i.e., the desired velocity V_{d} previously obtained by the motion restriction controller of the virtual dynamics model in FIG. 5 at the previous clock cycle of the operation system of the robotic device 100). In the case that the robot-guided trajectory mode Oᵣ is selected, in this desired velocity obtaining, the processing unit 110 may obtain, through a velocity regulator of the virtual dynamics model in the right part of FIG. 5, the calculated velocity V_{c} by regulating the received input velocity Vᵢ based on the desired velocity V_{d} at the previous time (block 441 of FIG. 7, see also step S441 of FIG. 6). The processing unit 110 may further obtain, through the motion restriction controller of the virtual dynamics model in the right part of FIG. 5, the desired velocity V_{d} for each motor at the current time by modifying, based on the generated motion restriction map Mm and the received current position Dₚ, the calculated velocity V_{c} (block 442 of FIG. 7).

The key concept of the IEVC mechanism is to predict the position of the end-effector in the next step and adjust the current velocity output (i.e., the calculated velocity V_{c}). FIG. 9A is a flow chart of an example of obtaining the desired velocity V_{d} according to some embodiments of the present disclosure; and FIG. 9B is a schematic diagram of calculating implicit Euler velocity control (IEVC) in the example of obtaining the desired velocity V_{d} in FIG. 9A. Accordingly, at step S4421, a circle C centered at the received current position Pᵢₙ (denoted as Dₚ in FIG. 5 and FIG. 7) with radius r proportional to the calculated velocity Vᵢₙ (denoted as V_{c} in FIG. 5 and FIG. 7) is drawn, where the radius r=Gᵥ*∥Vᵢₙ∥, and Gᵥ is proportional gain which needs to be adjusted by a transmission ratio between the velocity of the motor M and that of the end-effector. At step S4422, intersection points of the drawn circle C and the permitted area Aₚ (or the trajectory restriction Dᵣ) represented by the generated motion restriction map Mm are marked as candidate point P₁ and candidate point P₂. The IEVC mechanism will mark all the drawn circle's intersection points with the permitted area Aₚ as candidate points for the next chasing target. Here candidate point P₁ is selected due to higher directional alignment with the calculated velocity Vn. At step S4423, normalized vector R₁ and normalized vector R₂ are generated by pointing the current position Pₙ of the end-effector to each of the candidate point P₁ and the candidate point P₂. At step S4424, a final direction vector, that is, the normalized vector R₁ that have the most aligned direction with the calculated velocity Vₙ among the generated normalized vectors is found by, for example, iterating through an array of the generated vectors to find the vector that has the most aligned direction with the calculated velocity Vᵢₙ. At step S4425, the desired velocity Vᵣ (denoted as V_{d} in FIG. 5 and FIG. 7) is obtained by combining a direction of the found final direction vector R₁ with a negative clipped magnitude of a projection of the calculated velocity Vₙ onto the final direction vector R₁ (so that if the value of the projection is negative, its negative clipped value is 0, and if that value is positive, its clipped value is the number itself). That is, the desired velocity Vᵣ is the projection of the calculated velocity Vᵢₙ onto the direction of the candidate point P₁. The IEVC mechanism is stable because the restricted velocity (i.e., the desired velocity Vᵣ) it gives always target towards the permitted area Aₚ. Even when current position Pᵢₙ does not lie inside the permitted area Aₚ (trajectory), the error will decade exponentially over time steps and the IEVC mechanism can still effectively restrict the position of the end-effector on the area boundary of the permitted area Aₚ.

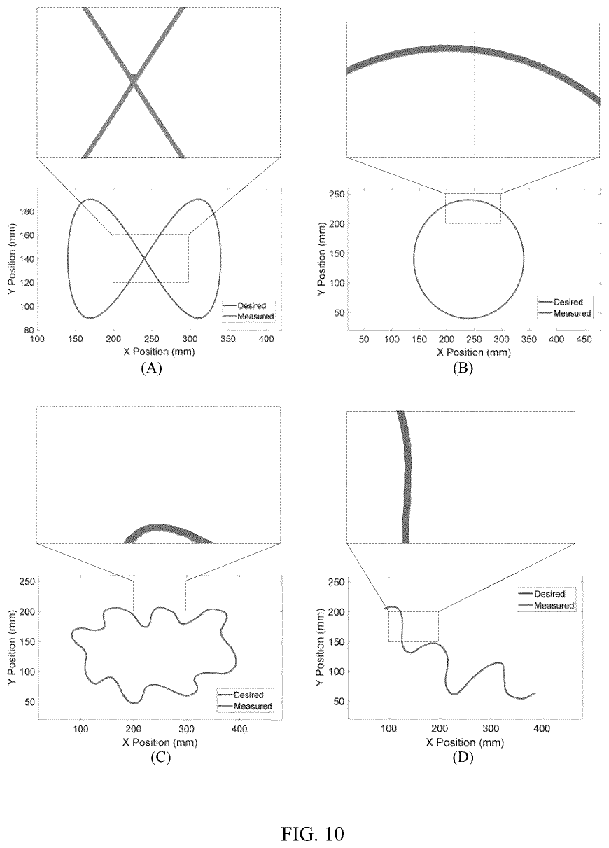

According to the upper limb rehabilitation process, the processing unit 110 may further provide, through the virtual dynamics model in FIG. 5, a movement instruction Iₘ including the obtained desired velocity V_{d} at the current time for each motor M (i.e., the X-axis motor M and the Y-axis motor M) (block 450 of FIG. 4). The processing unit 110 may further control, through the low-level firmware controller in FIG. 5, the end-effector (i.e., the hand holder 103) to move according to the provided movement instruction Iₘ (block 460 of FIG. 4). The end-effector may be to controlled to move by transmitting the movement instruction Iₘ for each motor M to the motor controller of the motor M in the low-level firmware controller so that the motor M rotates according to the desired velocity V_{d} in the received movement instruction Iₘ. By employing the non-backdrivable ball-screw-driven mechanism, the robotic device 10 is allowed to strictly follow the desired trajectory V_{d} without being affected by external forces exerted by the user U through the end-effector in the robot-guided trajectory mode Oᵣ. FIG. 10 is a schematic diagram of the desired positions and the measured positions of the end-effector and error analysis in the robot-guided trajectory mode Oᵣ. The user U who is a healthy subject operates the robot-guided trajectory mode Oᵣ on (function-based and hand-drawn) trajectories, and the robotic device 100 tracks the trajectories using the encoder E of each of the X-axis motor M and the Y-axis motor M. The desired positions of the end-effector and the measured positions of the end-effector on each trajectory are recorded and plotted on figures. The error is calculated by measuring the closest distance to the permitted area Aₚ for each recorded position of the end-effector if the end-effector is outside the permitted area Aₚ. Part (A) shows a function-based infinite shaped trajectory calculated using equation: x⁴−x²+y²=0, where the mean absolute error (MAE) between the desired positions and the measured positions of the end-effector is 0.00823 mm. Part (B) shows a function-based circle shaped trajectory calculated using equation: x²+y²−25²=0, where the MAE between the desired positions and the measured positions of the end-effector is 0.023 mm. Part (C) shows a hand-drawn circular trajectory, where the MAE between the desired positions and the measured positions of the end-effector is 0.00878 mm. Part (D) shows a hand-drawn line trajectory, where the MAE between the desired positions and the measured positions of the end-effector is 0.00763 mm. The average MAE of the four trajectories between the desired positions and the measured positions of the end-effector stands at 0.012 mm. Because the desired positions and the measured positions on each of the above-mentioned trajectories are highly overlapped and their differences can hardly differentiate from the figure even partially enlarged, it can be seen that the robot-guided trajectory mode Oᵣ here is efficient.

FIG. 11 is a schematic diagram of a control hierarchy of the free mode O_{f} and the hard-boundary human-guided trajectory mode Oₕ and that of the soft-boundary human-guided trajectory mode Oₛ of the robotic device 100 of FIG. 3. The upper part of FIG. 11 shows a two-level control hierarchy of the free mode O_{f} and the hard-boundary human-guided trajectory mode Oₕ, where the two-level control hierarchy includes a high-level virtual dynamics model and a low-level firmware controller similar to the high-level virtual dynamics model and the low-level firmware controller in FIG. 5. The control hierarchy of the hard-boundary human-guided trajectory mode Oₕ mirrors that of the free mode O_{f}, because under the proposed method the trajectory restriction (i.e., the trajectory restriction Dᵣ) and the area restriction are identical (see FIG. 9B). Compared to the two-level control hierarchy of the robot-guided trajectory mode Oᵣ shown in the right part of FIG. 5, an admittance virtual dynamics block is included in this virtual dynamics model rather than the velocity regulator of the virtual dynamics model in the right part of FIG. 5. This virtual dynamics model is required for controlling the above-mentioned non-backdrivable mechanism with sensor force (i.e., the input force D_{f}) as input and end-effector velocity (i.e., the desired velocity V_{d}) as output. The lower part of FIG. 11 shows a two-level control hierarchy of the soft-boundary human-guided trajectory mode Oₛ, where the two-level control hierarchy includes a high-level virtual dynamics model and a low-level firmware controller similar to the high-level virtual dynamics model and the low-level firmware controller in FIG. 5. The soft-boundary human-guided trajectory mode Oₛ permits greater flexibility in rehabilitation training, because the user U is allowed to guide the end-effector along a trajectory with soft boundaries, allowing deviations from the desired path. Automatic assistance force is applied to realign the end-effector with the trajectory when necessary. Compared to the two-level control hierarchy of the free mode O_{f} and the hard-boundary human-guided trajectory mode Oₕ shown in the upper part of FIG. 11, a restriction map and spring force map generator is included in this virtual dynamics model rather than the restriction map generator of the virtual dynamics model in the upper part of FIG. 11, and this virtual dynamics model further includes an impedance controller than the virtual dynamics model in FIG. 5 and that in the upper part of FIG. 11. The impedance controller realizes a soft boundary, which uses impedance control to provide the assistance force for trajectory realignment by calculating the net force (i.e., the compositional force F_{c}) for adjusting the end-effector based on the spring force map Mₛ and the current position Dₚ of the end-effector, and sends the result to the admittance virtual dynamics block of the virtual dynamics model for further computation. The impedance controller and the admittance virtual dynamics block are used together to simulate the permitted area Aₚ with spring-damper (impedance) boundary.

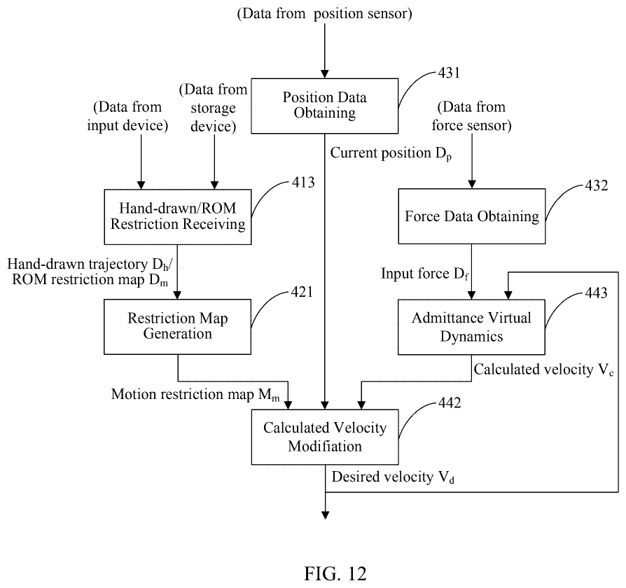

FIG. 12 is a schematic diagram of an example of obtaining the desired velocity V_{d} in the free mode O_{f} and the hard-boundary human-guided trajectory mode Oₕ. In the case that the free mode O_{f} is selected, in the trajectory restriction receiving (block 410 of FIG. 4), the processing unit 110 may receive the hand-drawn trajectory Dₕ or a ROM restriction map Dₘ that belongs to the trajectory restriction Dᵣ from the GUI controller of the virtual dynamics model in FIG. 5, (block 413, see also step S413 of FIG. 6); in the map generation (block 420 of FIG. 4), the processing unit 110 may generate, through a restriction map generator of the virtual dynamics model in upper part of FIG. 11 (i.e., the restriction map generator of the virtual dynamics model in FIG. 5), the motion restriction map Mₘ based on the received trajectory restriction Dᵣ (i.e., the hand-drawn trajectory Dₕ or the ROM restriction map Dm) (block 421 of FIG. 12, see also step S421 of FIG. 6); in the sensor data obtaining (block 430 of FIG. 4), the processing unit 110 may receive, through the position sensor (i.e., the encoder E) of the end-effector (i.e., the hand holder 103), the current position Dₚ of the end-effector (block 431 of FIG. 12), and the processing unit 110 may further receive, through the force sensor S of the end-effector, input force D_{f} (block 432 of FIG. 12); and in the desired velocity obtaining (block 440 of FIG. 4), the processing unit 110 may obtain, through the admittance virtual dynamics block of the virtual dynamics model in upper part of FIG. 11, the calculated velocity V_{c} based on the desired velocity V_{d} at the previous time and the input force D_{f} (block 443 of FIG. 7). Then, the processing unit 110 may further obtain, through a motion restriction controller of the virtual dynamics model in upper part of FIG. 11 (equivalent to the motion restriction controller of the virtual dynamics model in FIG. 5), the desired velocity V_{d} for the motor at the current time by modifying, based on the generated motion restriction map Mm and the received current position Dₚ, the calculated velocity V_{c} (block 442 of FIG. 7). The admittance virtual dynamics block performs an admittance virtual dynamics simulation mechanism to simulate an adjustable mass-friction-damper dynamics by emulating a virtual mass, static resistance, and speed damper, which allows the end-effector to move with simulated virtual dynamics so as to achieve natural sensation of free moving of the end-effector. Specifically, given a virtual mass, there have equations of motion in the Laplace domain of.

$$f = {sm}_{v} {vk}_{r} \qquad ( 1 )$$

$$\frac{v}{f} = \frac{1}{{m}_{v} {k}_{r}} \cdot \frac{1}{s}$$

where, f denotes the input force D_{f, s} denotes a time step size, mᵥ denotes the virtual mass, v denotes the desired velocity V_{d}, and kᵣ denotes a transmission ratio between the velocity of the motor M to that of the end-effector. Because the Laplacian domain model represented by equations (1) cannot be directly used for discrete control, it has to be converted into discrete control in two steps. First, take the Z-transform with Tustin estimator:

$$\frac{v}{f} = \frac{1}{{m}_{v} {k}_{r}} \cdot \frac{{T}_{s}}{2} \frac{𝓏 + 1}{𝓏 - 1} \qquad ( 2 )$$

$$⟹ v = \frac{{T}_{s}}{{m}_{v} {k}_{r}} \cdot \frac{f + {𝓏}^{- 1} f}{2} + {𝓏}^{- 1} v$$

where, Tₛ denotes the time step size (i.e., s in equations (1)). Second, transform the z-domain result represented by equations (2) back to the time domain to generate discrete control implementation:

$${v}_{k} = \frac{{T}_{s}}{{m}_{v} {k}_{r}} \cdot \frac{f + {f}_{k - 1}}{2} + {v}_{k + 1} \qquad ( 3 )$$

According to the equations (1), (2), and (3), in the calculated velocity modification (block 442 of FIG. 12), the calculated velocity V_{c} may be calculated according to an equation of:

$${v}_{c} = {v}_{k - 1} * ( 1 - {ζ}_{a} * {Y}_{m} ) + ( {f}_{k} + {f}_{k - 1} ) / 2 * {Y}_{m} ;$$

where, v_{c} represents the calculated velocity V_{c}, vₖ₋₁ represents the desired velocity V_{d} at time k−1, ζₐ represents a damping ratio, Yₘ represents dynamics of the robotic device 100 which is calculated using equation: Yₘ=Tₛ/mᵥ/kᵣ,fₖ represents the input force D_{f} at time k, and fₖ₋₁ represents the input force D_{f} at time k−1.

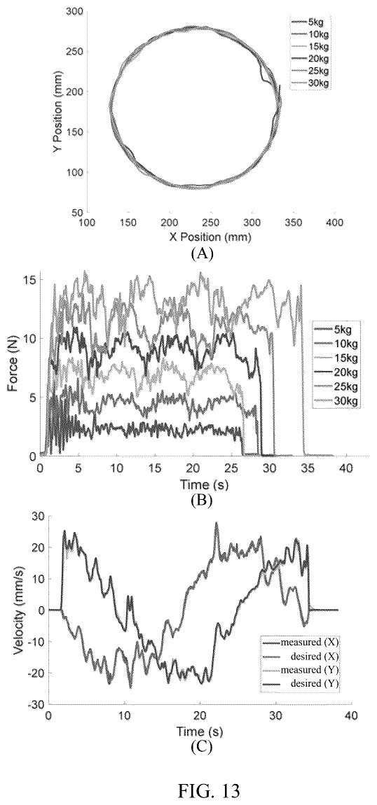

The free mode O_{f} has two primary functionalities. First, it incorporates the admittance virtual dynamics block to emulate the non-backdrivable end-effector as a free mass in the real world. Second, it enables free moving with the ROM restriction. The performance of the simulation of the admittance virtual dynamics block is the key for achieving the smooth and natural moving of the end-effector in the free mode O_{f} (and the hard-boundary human-guided trajectory mode Oₕ, too). FIG. 13 is a schematic diagram of an experiment of allowing six objects with different masses to move freely on task space with a friction coefficient of 0.02 by using admittance virtual dynamics (e.g., the admittance virtual dynamics block) in the free mode O_{f}. Part (A) and part (B) depict six experiments of circular motion performed using the free mode O_{f} by the user U who is a healthy subject instructed to follow an approximately circular trajectory, simulating objects with masses of 5, 10, 15, 20, 25, and 30 kilograms, moving freely on a plane with no motion restriction, bearing with a friction coefficient of 0.02. Part (C) demonstrates the desired velocities and the measured velocities of admittance control (in the X-axis and the Y-axis, respectively) when the end effector is moved in the approximately circular trajectory with 30 kg simulated object mass. It can be seen that for the object with the mass of 30 kilograms, the desired velocities and the measured velocities of the end effector in the X-axis are basically similar, and that in the Y-axis are basically similar, too. The overall outcomes are summarized in the following Table I which presents the performances of the admittance control in simulating the objects of six different masses moving in the approximately circular trajectory under the free mode O_{f}. The results in Table I indicate that the admittance virtual dynamics block can accurately simulate the objects with masses of 10-30 kilograms. However, when simulating the objects with 5 kilograms or lower masses, the end-effector experiences larger velocity error due to motor acceleration limit.

TABLE I

| Mass | 5 kg | 10 kg | 15 kg | 20 kg | 25 kg | 30 kg |
|---|---|---|---|---|---|---|
| Average measured end- | 2.08 | 3.98 | 6.04 | 8.08 | 9.87 | 11.36 |
| effector force (N) | | | | | | |
| MAE of X-axis desired and | 2.45 | 0.75 | 0.41 | 0.46 | 0.37 | 0.35 |
| measured velocity (mm/s) | | | | | | |
| MAE of Y-axis desired and | 6.66 | 1 | 0.88 | 0.68 | 0.73 | 0.56 |
| measured velocity (mm/s) | | | | | | |

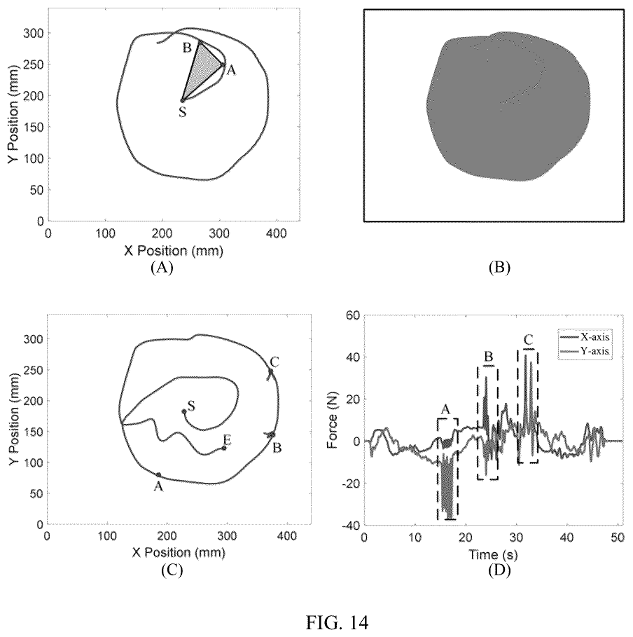

FIG. 14 is a schematic diagram of ROM restriction map generation and evaluation in the free mode O_{f}. The interaction with the ROM boundary resembles encountering a hard, smooth wall-like boundary, restricting the arm motion of the user U inside a safe workspace to avoid injuries. The ROM is defined as the area bounded by a closed trajectory traversed by the end-effector (i.e., the hand holder 103). The ROM restriction map Dm is generated by filling all triangles constructed by the starting point and two consecutive positions of the end-effector. Part (A) and part (B) demonstrate an example of the generation of the ROM restriction map Dₘ. In part (A), a trajectory of the end-effector that starts from starting point S is recorded during generating the ROM restriction map Dₘ, and points A and B are the positions of the end-effector that are recorded in sequence. In part (B), the trajectory recorded in part (A) is used to generate the ROM restriction map Dₘ. The ROM restriction map Dₘ is generated by drawing triangles between starting point S and two consecutive positions of the end-effector, that is, point A and point B and filling all the drawn triangles. The ROM is taken as the permitted area Aₚ is enclosed by the trajectory recorded in part (A) and marked gray. Part (C) and part (D) demonstrate an experiment in the free mode O_{f} that evaluates the ROM restriction map Dₘ generated in part (B). In part (C), a trajectory of the end effector that starts from starting point S and ends in finishing point E is shown, and both movement inside the ROM and movement interacting with the area boundary are contained in the experiment. The end-effector can move freely inside the ROM and interact with the hard, smooth, wall-like area boundary of the ROM, and the trajectory of the end effector shows the random motion within the ROM in the ROM restriction map Dₘ. Points A, B, and C are locations where the user U is trying to exceed the ROM limitation, that is, the area boundary of the ROM. In part (D), the forces measured on the end-effector from the random motion in part (C) are shown. Instances at points A, B, and C where dedicated forces (in the X-axis and the Y-axis) are applied to try to exceed the ROM limitation—yet the end-effector remains within the ROM—are highlighted by the dashed box, where boxes A, B, and C correspond to points A, B, and C in part (C), respectively. The result of the experiment demonstrates that in the free mode O_{f}, the motions of the end-effector can be efficiently restricted within the ROM restriction map Dₘ.

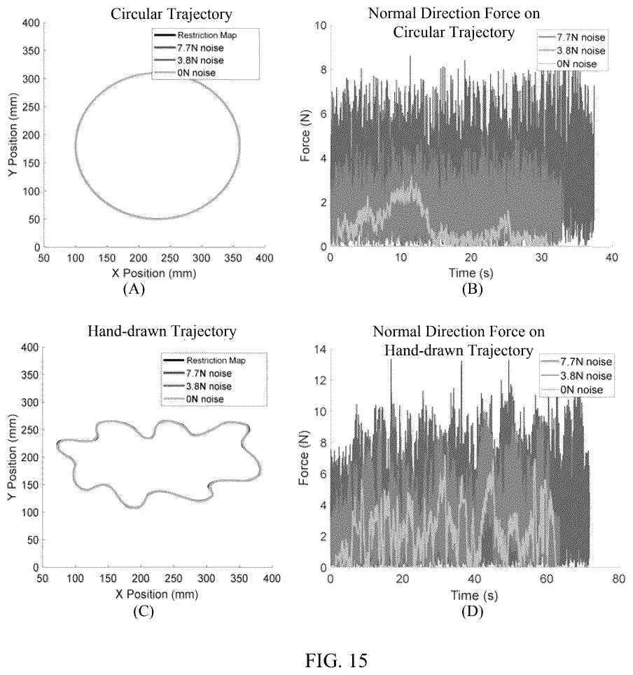

In the hard-boundary human-guided trajectory mode Oₕ, the user U can move the end-effector along a trajectory with a smooth hard boundary, sharing the same control hierarchy as the free mode O_{f} (see the upper part of FIG. 11). In the soft-boundary human-guided trajectory mode Oₛ, the user U can move the end-effector along a trajectory with a soft (impedance force) boundary, which will provide assistance force pulling the end-effector back towards the trajectory when the position deviate from the trajectory. Two key functionalities of the hard-boundary human-guided trajectory mode Oₕ and the soft-boundary human-guided trajectory mode Oₛ are highlighted. The first functionality involves the motion restriction method (performed by the motion restriction controller of the virtual dynamics model in upper part and lower part of FIG. 11, that is, the IEVC mechanism) applied to the trajectory to ensure the user U can only move the end-effector along the designed trajectory. The second functionality entails the impedance control mechanism (performed by the impedance controller of the virtual dynamics model in the lower part of FIG. 11), creating a soft boundary on the trajectory, simulating an impedance spring damper force toward the trajectory. There are two experiments to be conducted to verify the key functionalities of the hard-boundary human-guided trajectory mode Oₕ and the soft-boundary human-guided trajectory mode Oₛ. FIG. 15 is a schematic diagram of an experiment in the hard-boundary human-guided trajectory mode Oₕ with random noise injected. This first experiment aims to validate the performance of the IEVC on motion restricted control. There depicted a total of six trials of human-guided trajectory following on two different trajectory shapes under three different levels of random force injected into the end-effector as noise. The user U who is a healthy subject is asked to move the end-effector and complete one circular motion for each trial. During each trial, the motion restriction map Mm which only allow the end-effector to move on a thin trajectory is loaded to the motion restriction controller of the virtual dynamics model in upper part of FIG. 11, and a certain level of random noise is injected on the load cell during motion to simulate an undesired force which can possibly affect the motion of the end-effector. Part (A) depicts the end-effector moving on a circular trajectory in the motion restriction map Mm; and part (B) depicts the normal direction forces on the circular trajectory of part (A) in which three levels of random force are injected to the force sensor S of the end-effector as noise. It can be seen that the circular trajectories under different injected noises are almost overlap in the figure, and this result is optimal because the actual trajectory (i.e., the circular trajectories under different injected noises) basically overlaps with the desired trajectory (i.e., the circular trajectory in the motion restriction map Mm). Part (C) depicts the end-effector moving on a hand-drawn trajectory in the motion restriction map Mm; and part (D) depicts the normal direction forces on the hand-drawn trajectory of part (C) in which three levels of random force are injected to the force sensor S of the end-effector as noise. It can be seen the hand-drawn trajectories under different injected noises are basically identical because there are merely a few differences at some turns of the hand-drawn trajectories under different injected noises, and this result is optimal because the actual trajectory (i.e., the hand-drawn trajectories under different injected noises) basically overlaps with the desired trajectory (i.e., the hand-drawn trajectory in the motion restriction map Mm). The results in part (A) and part (C) show that the IEVC mechanism is robust against noisy end-effector input forces. The forgoing results demonstrate that in all trials, the recorded trajectory almost completely overlaps with the motion restriction map Mm, indicating that the IEVC mechanism effectively restricts the motion of the end-effector on the trajectory. Table II presents the quantitative MAE of each trial in the hard-boundary human-guided trajectory mode Oₕ with random noise injected. The error is calculated by measuring the closest distance to the permitted area Aₚ for each recorded position of the end-effector if the end-effector is outside the permitted area Aₚ. The results show that the error decreases under higher noise levels, which is because the error of the IEVC mechanism depends only on the moving speed and the trajectory. A large injection noise makes it difficult for the user U to move the end effector, thus reducing the error. The results of this first experiment demonstrate that the IEVC mechanism can effectively restrict the motion of the end-effector within any permitted area Aₚ, making it an ideal choice for the motion restriction controller of the virtual dynamics model in upper part of FIG. 11.

TABLE II

| Trajectory | | | | Hand- | Hand- | Hand- |
|---|---|---|---|---|---|---|
| Type Noise | Circular | Circular | Circular | drawn | drawn | drawn |
| magnitude | 0N | 3.8N | 7.7N | 0N | 3.8N | 7.7N |
| MAE (mm) | 0.067 | 0.061 | 0.032 | 0.134 | 0.115 | 0.113 |

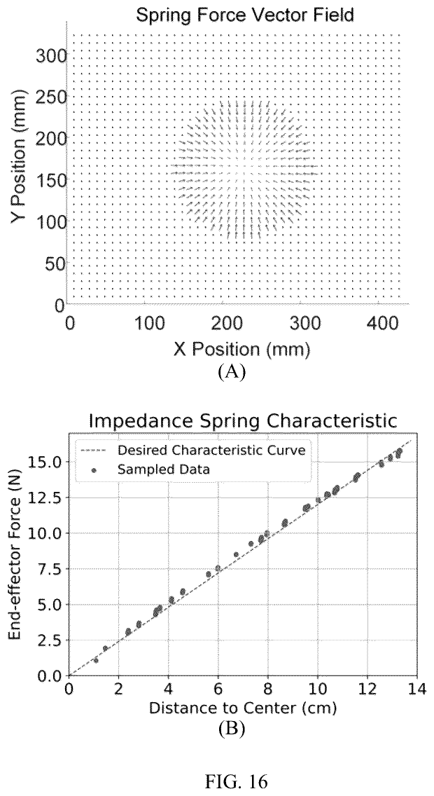

FIG. 16 is a schematic diagram of an experiment of characteristics of an impedance force zone in the soft-boundary human-guided trajectory mode Oₛ. This second experiment involves free moving inside the impedance force zone (see the generated impedance force zone in part (B) of FIG. 18) with a radius of 14 cm. The spring force map Mₛ is generated using the method in FIG. 8 with a special motion restriction map Mm that has the permitted area Aₚ only at the center location of the task space. Part (A) shows the derived impedance spring force vector field where every permitted location has an impedance spring force pointing towards the center with a magnitude proportional to the distance from the center. In part (B), the user U is asked to move and hold the end-effector at different locations in the impedance force zone. When the end-effector is at zero acceleration (force equilibrium), the distance between its current position and the center, as well as the current applied force on the end effector (i.e., the input force D_{f}), are recorded and plotted in part (B). The results of this second experiment demonstrate that the characteristic curve of simulated spring area nicely aligned with the characteristic curve of an ideal spring, which concludes that the impedance control mechanism (or the impedance controller of the virtual dynamics model in the lower part of FIG. 11) is effective.

FIG. 17 is a schematic diagram of an example of obtaining the desired velocity V_{d} in the soft-boundary human-guided trajectory mode Oₛ. In some embodiments, a generalized method capable of controlling along any given trajectory may be provided by entailing computer vision inspired numerical trajectory gradient generation to determine the direction of force assistance or resistance, coupled with a series of admittance and impedance controls on the end-effector. In the case that the soft-boundary human-guided trajectory mode Oₛ is selected, in the trajectory restriction receiving (block 410 of FIG. 4), the processing unit 110 may receive the hand-drawn trajectory Dₕ or the ROM restriction map Dm that belongs to the trajectory restriction Dᵣ from a GUI controller of the virtual dynamics model in lower part of FIG. 11, (block 413, see also step S413 of FIG. 6); in the map generation (block 420 of FIG. 4), the processing unit 110 may generate, through the restriction map and spring force map generator of the virtual dynamics model in lower part of FIG. 11, the motion restriction map Mm based on the received trajectory restriction Dᵣ (i.e., the hand-drawn trajectory Dₕ or the ROM restriction map Dₘ) (block 421, see also step S421 of FIG. 6), and the processing unit 110 may further generate, through the restriction map and spring force map generator, the spring force map Mₛ (see the generated spring force map Mₛ in part (C) of FIG. 18) based on the generated motion restriction map Mm (block 422, see also step S422 of FIG. 6); in the sensor data obtaining (block 430 of FIG. 4), the processing unit 110 may receive, through the position sensor (i.e., the encoder E) of the end-effector (i.e., the hand holder 103), the current position Dₚ of the end-effector (block 431), and the processing unit 110 may further receive, through the force sensor S of the end-effector, the input force D_{f} (block 432); in the desired velocity obtaining (block 440 of FIG. 4), the processing unit 110 may first calculate, through the impedance controller in lower part of FIG. 11, the compositional force F_{c} based on the spring force map Mₛ, the current position Dₚ of the end-effector, the input force D_{f}, and the desired velocity V_{d} at the previous time (block 444); the processing unit 110 may further obtain, through an admittance virtual dynamics block of the virtual dynamics model in lower part of FIG. 11 (similar to the admittance virtual dynamics block of the virtual dynamics model in upper part of FIG. 11), the calculated velocity V_{c} based on the desired velocity V_{d} at the previous time and the input force D_{f} (block 443); and the processing unit 110 may further obtain, through a motion restriction controller of the virtual dynamics model in lower part of FIG. 11 (equivalent to the motion restriction controller of the virtual dynamics model in FIG. 5), the desired velocity V_{d} for the motor at the current time by modifying, based on the generated motion restriction map Mₘ and the received current position Dₚ, the calculated velocity V_{c} (block 442). In the spring force map generation (block 422), at step S4221 of FIG. 8, a simulated impedance spring force Fₛ (not shown) is obtained based on a one-flipped convolution result between the motion restriction map Mₘ and an impulse convolution kernel. At step S4222, a simulated impedance damper force F_{d} (not shown) is obtained based on a direction of the impedance spring force Fₛ and the desired velocity V_{d} for each motor M at the previous time (i.e., time k−1). At step S4223, a compositional force F_{c} is obtained by compositing the input force Di with the simulated impedance spring force Fₛ and the simulated impedance damper force F_{d}.

By introducing a numerical solution to provide force assistance or resistance along any 2D trajectory including the hand-drawn trajectory Dₕ, the customization of trajectory tracking for individual user is realized. FIG. 18 is a schematic diagram of an example of calculating impedance force for the hand-drawn motion restriction map Mₘ in the soft-boundary human-guided trajectory mode Oₛ. The impedance force (i.e., the impedance spring force and the impedance damper force) is computed using the spring force map Mₛ, where the spring force map Mₛ is generated in advance using a 2D convolution between the motion restriction map Mₘ and a 2D uniformly filled circular kernel. The direction of the impedance spring force Fₛ may be computed by the negative local gradient direction of the spring force map Mₛ at the current position Dₚ of the end-effector. Part (A) shows the original hand-drawn motion restriction map Mₘ, that is, the original motion restriction map Mₘ generated based on the hand-drawn trajectory Dₕ. For calculating the impedance force for the hand-drawn motion restriction map Mₘ in the soft-boundary human-guided trajectory mode Oₛ, the first step is to expand the given trajectory in the radial direction. Part (B) shows the resulting expanded motion restriction map Mₘ using a 6 mm radius uniformly filled circular kernel. The generated impedance force zone will be centered at the original boundary location with a width equal to the diameter of the convolution kernel. Therefore, the permitted area Aₚ (or permitted trajectory) needs to be expanded in the radial direction by the radius of the convolution kernel to create space for the impedance force zone. The expansion may be achieved through convolution using the same 2D uniformly filled circular kernel, followed by thresholding the resultant output (setting x to 1 if x>0, otherwise to 0 for all x in (Mᵣₛ\textcircled{*}Kernal_{cir})). Then, the spring force map Mₛ for any given trajectory including the hand-drawn trajectory Dₕ (or ROM) may be generated. Part (C) shows the generated spring force map Mₛ with a 12 mm impedance force zone along the trajectory. The width of the impedance force zone may be controlled by the diameter of the circular kernel. Part (D) shows the impedance spring force vector field derived based on the spring force map Mₛ of Part (C).

In comparison with the existing robotic device, the robotic device is a novel upper limb rehabilitation device in its design and control mechanisms. First, its non-backdrivable configuration enables the separation of simulated dynamics and robot dynamics to facilitate the implementation of controllers, and a simple structure and enhanced durability is ensured by utilizing the ball screws for linear actuation along the X-axis and the Y-axis. Second, the forgoing three control mechanisms (or algorithms) namely the IEVC mechanism, the admittance virtual dynamics simulation mechanism, and the impedance control mechanism are novel and have their advantages over the existing related control mechanisms, respectively. Specifically, the IEVC mechanism is highlighted for its state-of-the-art accuracy, stability, efficiency and generalizability in solving the problem of motion restriction control, which allows for trajectory and ROM adjustments without analytical constraints and with zero cost on additional obstacles or permitted area while can be adapted to any robot supporting end-effector velocity control; the admittance virtual dynamics simulation mechanism achieves smooth and natural human-guided motion of the non-backdrivable end-effector by simulating the motion of a virtual mass and applying this simulated motion to the end-effector; and the impedance control mechanism allows impedance control on any given trajectory or area boundary.

It can be understood by those skilled in the art that, all or part of the method in the above-mentioned embodiment(s) can be implemented by one or more computer programs to instruct related hardware. In addition, the one or more programs can be stored in a non-transitory computer readable storage medium. When the one or more programs are executed, all or part of the corresponding method in the above-mentioned embodiment(s) is performed. Any reference to a storage, a memory, a database or other medium may include non-transitory and/or transitory memory. Non-transitory memory may include read only memory (ROM), programmable ROM (PROM), electrically programmable ROM (EPROM), electrically erasable programmable ROM (EEPROM), flash memory, solid-state drive (SSD), or the like. Volatile memory may include random access memory (RAM), external cache memory, or the like.

The processing unit 110 (and the above-mentioned processor) may include central processing unit (CPU), or be other general-purpose processor, graphics processing unit (GPU), digital signal processor (DSP), application specific integrated circuit (ASIC), field-programmable gate array (FPGA), or be other programmable logic device, discrete gate, transistor logic device, and discrete hardware component. The general-purpose processor may be microprocessor, or the processor may also be any conventional processor. The storage unit 120 (and the above-mentioned memory) may include internal storage unit such as hard disk and internal memory. The storage unit 120 may also include external storage device such as plug-in hard disk, smart media card (SMC), secure digital (SD) card, and flash card.

The exemplificative units/modules and methods/steps described in the embodiments may be implemented through software, hardware, or a combination of software and hardware. Whether these functions are implemented through software or hardware depends on the specific application and design constraints of the technical schemes. The above-mentioned path planning method and mobile machine may be implemented in other manners. For example, the division of units/modules is merely a logical functional division, and other division manner may be used in actual implementations, that is, multiple units/modules may be combined or be integrated into another system, or some of the features may be ignored or not performed. In addition, the above-mentioned mutual coupling/connection may be direct coupling/connection or communication connection, and may also be indirect coupling/connection or communication connection through some interfaces/devices, and may also be electrical, mechanical or in other forms.

The above-mentioned embodiments are merely intended for describing but not for limiting the technical schemes of the present disclosure. Although the present disclosure is described in detail with reference to the above-mentioned embodiments, the technical schemes in each of the above-mentioned embodiments may still be modified, or some of the technical features may be equivalently replaced, so that these modifications or replacements do not make the essence of the corresponding technical schemes depart from the spirit and scope of the technical schemes of each of the embodiments of the present disclosure, and should be included within the scope of the present disclosure.

What is claimed is:

1. A method for controlling a robotic device having a non-backdrivable end-effector including at least a motor and at least a position sensor, comprising:
receiving at lease a trajectory restriction;
generating a motion restriction map based on the received trajectory restriction;
receiving, through the position sensor of the end-effector, a current position of the end-effector;
obtaining a desired velocity for the motor of the end-effector at a current time by modifying, based on the generated motion restriction map and the received current position, a calculated velocity obtained based on the desired velocity at a previous time to limit the end-effector to move inside a permitted area represented by the motion restriction map;
providing a movement instruction including the obtained desired velocity at the current time; and
controlling the end-effector to move according to the provided movement instruction.

2. The method of claim 1, wherein obtaining the desired velocity for the motor of the end-effector at the current time by modifying, based on the generated motion restriction map and the received current position, the calculated velocity obtained based on the desired velocity at the previous time to limit the end-effector to move inside the permitted area represented by the motion restriction map comprises:
drawing a circle centered at the received current position with radius proportional to the calculated velocity;
marking intersection points of the drawn circle and the permitted area represented by the generated motion restriction map as candidate points; and
obtaining the desired velocity for the motor by projecting the calculated velocity onto a direction of the candidate point with the highest directional alignment with the calculated velocity among the candidate points.

3. The method of claim 2, wherein obtaining the desired velocity for the motor by projecting the calculated velocity onto the direction of the candidate point with the highest directional alignment with the calculated velocity among the candidate points comprises:
generating normalized vectors by pointing the current position of the end-effector to each of the candidate points;
finding a final direction vector having the most aligned direction with the calculated velocity among the generated normalized vectors; and
obtaining the desired velocity for the motor by combining the final direction vector with a negative clipped magnitude of a projection of the calculated velocity onto the final direction vector.

4. The method of claim 1, wherein before obtaining the desired velocity for the motor of the end-effector at the current time by modifying, based on the generated motion restriction map and the received current position, the calculated velocity obtained based on the desired velocity at the previous time to limit the end-effector to move inside the permitted area represented by the motion restriction map, the method further comprises:
receiving an input velocity; and
obtaining the calculated velocity by regulating the received input velocity based on the desired velocity at the previous time.

5. The method of claim 1, wherein before obtaining the desired velocity for the motor of the end-effector at the current time by modifying, based on the generated motion restriction map and the received current position, the calculated velocity obtained based on the desired velocity at the previous time to limit the end-effector to move inside the permitted area represented by the motion restriction map, the method further comprises:
calculating the calculated velocity according to an equation of:
$${v}_{c} = {v}_{k - 1} * ( 1 - {ζ}_{a} * {Y}_{m} ) + ( {f}_{k} + {f}_{k - 1} ) / 2 * {Y}_{m} ;$$
where, v_{c} represents the calculated velocity, vₖ₋₁ represents the desired velocity at time k−1, ζₐ represents a damping ratio, Yₘ represents dynamics of the robotic device, f represents the input force at time k, and fₖ₋₁ represents the input force at time k₋₁; where, Yₘ=Tₛ/mᵥ/kᵣ, mᵥ represents a virtual mass, and kᵣ represents a transmission ratio between the velocity of the motor to the velocity of the end-effector.

6. The method of claim 5, wherein the end-effector further includes a force sensor; and before calculating the calculated velocity, the method further comprises:
obtaining, through the force sensor of the end-effector, the input force.

7. The method of claim 6, further comprising:
obtaining a simulated impedance spring force based on a one-flipped convolution result between the motion restriction map and an impulse convolution kernel;
obtaining a simulated impedance damper force based on a direction of the impedance spring force and the desired velocity at the previous time; and
compositing the input force with the simulated impedance spring force and the simulated impedance damper force.

8. The method of claim 1, wherein generating the motion restriction map based on the received trajectory restriction comprises:
discretizing a task space of the end-effector into a plurality of positions; and
generating the motion restriction map having elements corresponding to the positions in a one-to-one manner, wherein each of the elements stores a value indicating whether the corresponding position is in a prohibited area for the end-effector or the permitted area; and
initialing the values of all the elements of the motion restriction map with 0.

9. The method of claim 8, wherein when the trajectory restriction is defined using a hand-drawn trajectory, generating the motion restriction map based on the received trajectory restriction further comprises:
iterating through all the elements to assign the value of 1 to each of the elements belong to a permitted area defined by the hand-drawn trajectory.

10. The method of claim 8, wherein when the trajectory restriction is defined using a function, generating the motion restriction map based on the received trajectory restriction further comprises:
iterating through all the elements to assign the value of 1 to each of the elements with an absolute value less than a trajectory width for the trajectory restriction.

11. A robotic device, comprising:
a non-backdrivable end-effector including at least a motor and at least a position sensor;
one or more processors; and
one or more memories storing one or more programs configured to be executed by the one or more processors, wherein the one or more programs comprise instructions for:
receiving at lease a trajectory restriction;
generating a motion restriction map based on the received trajectory restriction;
receiving, through the position sensor of the end-effector, a current position of the end-effector;
obtaining a desired velocity for the motor of the end-effector at a current time by modifying, based on the generated motion restriction map and the received current position, a calculated velocity obtained based on the desired velocity at a previous time to limit the end-effector to move inside a permitted area represented by the motion restriction map;
providing a movement instruction including the obtained desired velocity at the current time; and
controlling the end-effector to move according to the provided movement instruction.

12. The robotic device of claim 11, wherein the instructions for obtaining the desired velocity for the motor of the end-effector at the current time by modifying, based on the generated motion restriction map and the received current position, the calculated velocity obtained based on the desired velocity at the previous time to limit the end-effector to move inside the permitted area represented by the motion restriction map comprise instructions for:
drawing a circle centered at the received current position with radius proportional to the calculated velocity;
marking intersection points of the drawn circle and the permitted area represented by the generated motion restriction map as candidate points; and
obtaining the desired velocity for the motor by projecting the calculated velocity onto a direction of the candidate point with the highest directional alignment with the calculated velocity among the candidate points.

13. The robotic device of claim 12, wherein the instructions for obtaining the desired velocity for the motor by projecting the calculated velocity onto the direction of the candidate point with the highest directional alignment with the calculated velocity among the candidate points comprise instructions for:
generating normalized vectors by pointing the current position of the end-effector to each of the candidate points;
finding a final direction vector having the most aligned direction with the calculated velocity among the generated normalized vectors; and
obtaining the desired velocity for the motor by combining the final direction vector with a negative clipped magnitude of a projection of the calculated velocity onto the final direction vector.

14. The robotic device of claim 12, wherein the one or more programs further comprise instructions for:
receiving an input velocity; and
obtaining the calculated velocity by regulating the received input velocity based on the desired velocity at the previous time.

15. The robotic device of claim 11, wherein the one or more programs further comprise instructions for:
calculating the calculated velocity according to an equation of:
$${v}_{c} = {v}_{k - 1} * ( 1 - {ζ}_{a} * {Y}_{m} ) + ( {f}_{k} + {f}_{k - 1} ) / 2 * {Y}_{m} ;$$
where, v_{c} represents the calculated velocity, vₖ₋₁ represents the desired velocity at time k−1, ζₐ represents a damping ratio, Yₘ represents dynamics of the robotic device, f represents the input force at time k, and fₖ₋₁ represents the input force at time k₋₁;
where, Yₘ=Tₛ/mᵥ/kᵣ, mᵥ represents a virtual mass, and kᵣ represents a transmission ratio between the velocity of the motor to the velocity of the end-effector.

16. The robotic device of claim 15, wherein the end-effector further includes a force sensor; and the one or more programs further comprise instructions for:
obtaining, through the force sensor of the end-effector, the input force.

17. The robotic device of claim 16, wherein the one or more programs further comprise instructions for:
obtaining a simulated impedance spring force based on a one-flipped convolution result between the motion restriction map and an impulse convolution kernel;
obtaining a simulated impedance damper force based on a direction of the impedance spring force and the desired velocity at the previous time; and
compositing the input force with the simulated impedance spring force and the simulated impedance damper force.

18. The robotic device of claim 11, wherein the instructions for generating the motion restriction map based on the received trajectory restriction comprise instructions for:
discretizing a task space of the end-effector into a plurality of positions; and
generating the motion restriction map having elements corresponding to the positions in a one-to-one manner, wherein each of the elements stores a value indicating whether the corresponding position is in a prohibited area for the end-effector or the permitted area; and
initialing the values of all the elements of the motion restriction map with 0.

19. The robotic device of claim 18, wherein when the trajectory restriction is defined using a hand-drawn trajectory, the instructions for generating the motion restriction map based on the received trajectory restriction further comprises instructions for:
iterating through all the elements to assign the value of 1 to each of the elements belong to a permitted area defined by the hand-drawn trajectory.

20. The robotic device of claim 8, wherein when the trajectory restriction is defined using a function, the instructions for generating the motion restriction map based on the received trajectory restriction further comprises instructions for:
iterating through all the elements to assign the value of 1 to each of the elements with an absolute value less than a trajectory width for the trajectory restriction.
